(19) United States
(12) Patent Application Publication
(10) Pub. No.: US 2018/0039144 A1
(43) Pub. Date: Feb. 8, 2018

(54) LIQUID CRYSTAL PANELS AND DISPLAY DEVICES

(71) Applicant: Shenzhen China Star Optoelectronics Technology Co. Ltd., Shenzhen, Guangdong (CN)

(72) Inventor: Sikun HAO, Shenzhen, Guangdong (CN)

(73) Assignee: Shenzhen China Star Optoelectronics Technology Co. Ltd., Shenzhen, Guangdong (CN)

(21) Appl. No.: 14/914,261

(22) PCT Filed: Jan. 28, 2016
(86) PCT No.: PCT/CN2016/072551

§ 371 Date: Feb. 25, 2016

(30) Foreign Application Priority Data
Jan. 5, 2016 (CN) 201610005668.4

(51) Int. Cl. G02F 1/1343; G02F 1/1368; G02F 1/1335

(52) U.S. Cl. CPC G02F 1/134363; G02F 1/13439; G02F 1/133514; G02F 1/1368; G02F 2201/123; G02F 2201/121

(57) ABSTRACT

A liquid crystal panel includes a first substrate, a second substrate spaced apart from the first substrate, and a liquid crystal layer between the first substrate and the second substrate. The second substrate includes an ITO layer facing toward the liquid crystal layer, the ITO layer comprises at least one first pixel electrode layer, at least one common electrode layer, and at least one second pixel electrode layer spaced apart from each other. A first voltage difference between the first pixel electrode layer and the common electrode layer is different from a second voltage difference between the second pixel electrode layer and the common electrode layer. In this way, the intensity of the horizontal electrical field above the common electrode layer is enhanced such that the transmission rate of the liquid crystal panel may be increased.

### BACKGROUND OF THE INVENTION

### 1. Field of the Invention

The present disclosure relates to liquid crystal display technology, and more particularly to a liquid crystal panel and a display device.

### 2. Discussion of the Related Art

The liquid crystal display panel is the most widely used flat panel display, which has been adopted as high-resolution color display in a variety of electronic devices such as mobile phones, personal digital assistants (PDA), a digital camera, a laptop computer screen. With the development and progress of the liquid crystal display panel technology, higher demands toward display performance, design, low cost and high transmittance are increased.

With respect to the LCD IPS mode (flat control) display panel, viewers can only see the short axis of the liquid crystal molecules at any moments, such that the images remain quite the same when the viewing angles are different. As such, the viewing angle of the liquid crystal panel of IPS mode may be enhanced. However, as shown in FIGS. 1 and 2, within the internal structure of the liquid crystal panel, the ITO layer includes a pixel electrode layer 121 and a common electrode layer 122. The driving voltages applied to the pixel electrode layer 121 are equal such that the voltage differences between the common electrode layer 122 and the adjacent pixel electrode layer 121 are the same. In addition, as the common electrode layer 122 and the pixel electrode layer 121 are arranged on the same side of the substrate, the strength of the horizontal electrical field above the common electrode layer 122 is weak and it is difficult for the liquid crystals to rotate. As such, the transmission rate of the liquid crystal panel of IPS mode is low, and the display performance may be affected.

In view of the above, it is necessary to provide a liquid crystal panel and a display device to overcome the above problems.

### SUMMARY

The present disclosure relates to a liquid crystal panel and a display device for enhancing the strength of the horizontal electrical field above the common electrode layer so as to enhance the display performance.

In one aspect, a liquid crystal panel includes: a first substrate, a second substrate spaced apart from the first substrate, and a liquid crystal layer between the first substrate and the second substrate, the second substrate includes an ITO layer facing toward the liquid crystal layer, the ITO layer includes at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer; wherein the first voltage difference between the first pixel electrode layer and the common electrode layer is opposite to the second voltage difference between the second pixel electrode layer and the common electrode layer; the common electrode layer is arranged between the first pixel electrode layer and the second pixel electrode layer, and the first pixel electrode layer or the second pixel electrode layer is arranged between two common electrode layers; and the liquid crystal panel is the liquid crystal panel of IPS mode.

Wherein a first driving voltage value of the first pixel electrode layer is different from a second driving voltage value of the second pixel electrode layer.

Wherein a voltage value of the common electrode layer is larger than the first driving voltage value of the adjacent first pixel electrode layer, and is smaller than the second driving voltage value of the adjacent second pixel electrode layer.

Wherein the first substrate is a color filter array substrate, and the second substrate is a thin film transistor (TFT) array substrate.

In another aspect, a liquid crystal panel includes: a first substrate, a second substrate spaced apart from the first substrate, and a liquid crystal layer between the first substrate and the second substrate, the second substrate includes an ITO layer facing toward the liquid crystal layer, the ITO layer includes at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer.

Wherein the common electrode layer is arranged between the first pixel electrode layer and the second pixel electrode layer, and the first pixel electrode layer or the second pixel electrode layer is arranged between two common electrode layers.

Wherein a first driving voltage value of the first pixel electrode layer is different from a second driving voltage value of the second pixel electrode layer.

Wherein a voltage value of the common electrode layer is larger than the first driving voltage value of the adjacent first pixel electrode layer, and is smaller than the second driving voltage value of the adjacent second pixel electrode layer.

Wherein the first voltage difference is in a range between 0 and 10V and the second voltage difference is in a range between −10 and 0 V.

Wherein the second voltage difference is in a range between 0 and 10 V, and the first voltage difference is in a range between −10 and 0 V.

Wherein the liquid crystal panel is the liquid crystal panel of IPS mode.

Wherein the first substrate is a color filter array substrate, and the second substrate is a TFT array substrate.

In another aspect, a display device includes: a liquid crystal panel including a first substrate, a second substrate spaced apart from the first substrate, and a liquid crystal layer between the first substrate and the second substrate, the second substrate includes an ITO layer facing toward the liquid crystal layer, the ITO layer includes at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer.

Wherein the common electrode layer is arranged between the first pixel electrode layer and the second pixel electrode layer, and the first pixel electrode layer or the second pixel electrode layer is arranged between two common electrode layers.

Wherein a first driving voltage value of the first pixel electrode layer is different from a second driving voltage value of the second pixel electrode layer.

Wherein a voltage value of the common electrode layer is larger than the first driving voltage value of the adjacent first pixel electrode layer, and is smaller than the second driving voltage value of the adjacent second pixel electrode layer.

Wherein the first voltage difference is in a range between 0 and 10V and the second voltage difference is in a range between −10 and 0 V.

Wherein the second voltage difference is in a range between 0 and 10 V, and the first voltage difference is in a range between −10 and 0 V.

Wherein the liquid crystal panel is the liquid crystal panel of IPS mode.

Wherein the first substrate is a color filter array substrate, and the second substrate is a TFT array substrate.

In view of the above, the first voltage difference between the common electrode layer and the first pixel electrode layer is different from the second voltage difference between the common electrode layer and the second pixel electrode layer. The intensity of the horizontal electrical field above the common electrode layer may be increased and the transmission rate of the liquid crystal panel may also be enhanced. In addition, the performance of the liquid crystal panel may be enhanced, and the design cost may be reduced.

### BRIEF DESCRIPTION OF THE DRAWINGS

FIG. 1 is a schematic view of the conventional liquid crystal panel.

FIG. 2 is a schematic view of the transmission rate of the liquid crystal panel of FIG. 1 along the locations of the electrode layer of

FIG. 3 is a schematic view of the liquid crystal panel in accordance with one embodiment.

FIG. 4 is a schematic view of the transmission rate of the liquid crystal panel of FIG. 3 along the locations of the electrode layer of

FIG. 5 is a comparison diagram of the transmission rates of the liquid crystal panel of the claimed invention and of the conventional liquid crystal panel.

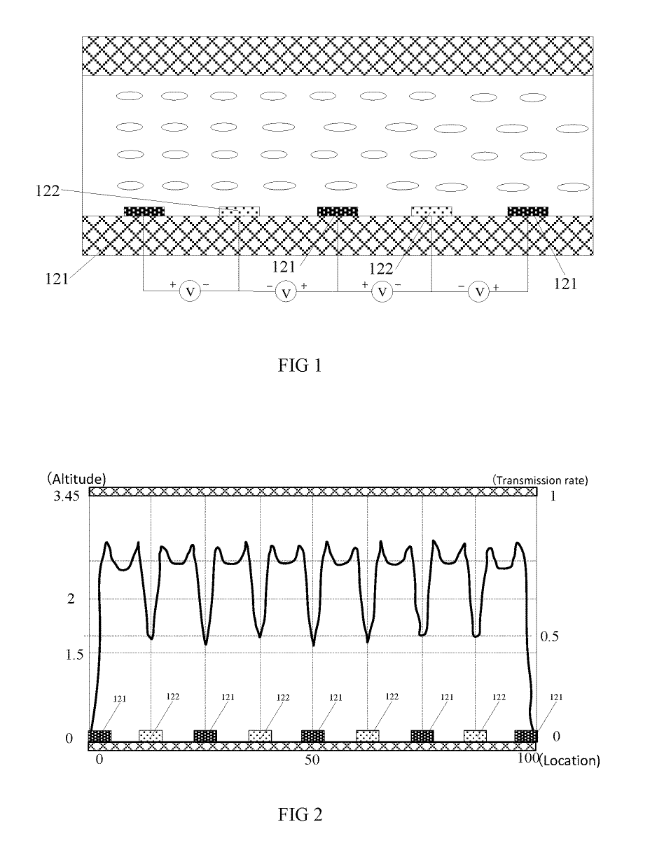

### DETAILED DESCRIPTION OF THE EMBODIMENTS

Embodiments of the invention will now be described more fully hereinafter with reference to the accompanying drawings, in which embodiments of the invention are shown.

The present disclosure relates to a display device including a liquid crystal panel. Preferably, the liquid crystal panel is the liquid crystal panel of IPS mode. Specifically, the liquid crystal panel may be the liquid crystal panel adopting a brand new liquid crystal configuration for overcoming the shortages of the TN mode regarding the first generation IPS, so as to realize a better visible angle. In another example, the liquid crystal panel may be the liquid crystal panel adopting the second generation IPS technology, i.e., S-IPS or Super-IPS, which includes “ [symbol] ”-shaped electrode and a dual-domains mode. With such configuration, the grayscale reverse phenomenon at some specific angles may be enhanced. In another example, the liquid crystal panel may be the liquid crystal panel adopting the third generation IPS technology, i.e., AS-IPS or Advanced Super-IPS, which decreases the gap between the liquid crystal molecules to increase the aperture rate and to enhance the brightness.

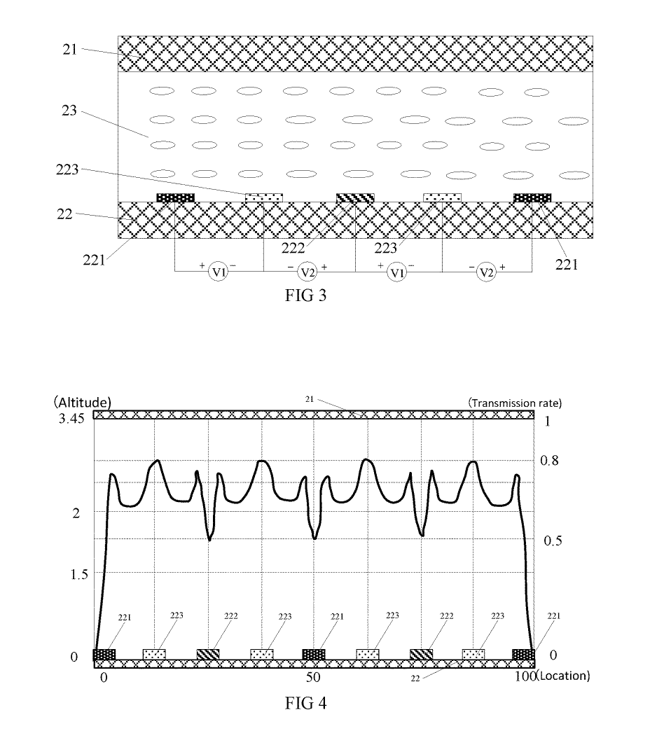

FIG. 3 is a schematic view of the liquid crystal panel in accordance with one embodiment. The liquid crystal panel includes a first substrate 21, a second substrate 22 spaced apart from the first substrate 21, and a liquid crystal layer 23 between the first substrate 21 and the second substrate 22. In the embodiment, the first substrate 21 is a color filter array substrate, and the second substrate 22 is a thin film transistor (TFT) array substrate.

The second substrate 22 includes an ITO layer facing toward the liquid crystal layer. The ITO layer includes a plurality of first pixel electrode layers 221, common electrode layers 222, and second pixel electrode layers 223 spaced apart from each other. Preferably, the common electrode layer 222 is arranged between the first pixel electrode layer 221 and the second pixel electrode layer 223. One first pixel electrode layer 221 or one second pixel electrode layer 223 is arranged between two common electrode layers 222. Specifically, the ITO layer is configured with the cyclical sequence including first pixel electrode layer 221, the common electrode layer 222, and the second pixel electrode layer 223, and the common electrode layer 222.

It should be understood that the ITO layer is not limited to the above sequence. In other embodiments, the common electrode layer 222 is arranged between two first pixel electrode layers 221, and the common electrode layer 222 is arranged between the two second pixel electrode layers 223.

A first driving voltage value of the first pixel electrode layer 221 is different from a second driving voltage value of the second pixel electrode layer 223, and the driving voltage values of each of the common electrode layers 222 are equal. Thus, in the embodiment, the first voltage difference between the first pixel electrode layer 221 and the common electrode layer 222 is different from the second voltage difference between the second pixel electrode layer 223 and the common electrode layer 222. Thus, as the first driving voltage value is different from the second driving voltage value, the magnetic field above the common electrode layer 222 may change. Compared to the original magnetic field, the magnetic field above the common electrode layer 222 increases greatly so as to change the transmission rate around and above the common electrode layer 222, which also increases the transmission rate of the liquid crystal panel.

In the embodiment, the first voltage difference is in a range between 0 and 10V and the second voltage difference is in a range between −10 and 0 V. In other embodiments, the second voltage difference may be in a range between 0 and 10 V, and the first voltage difference may be in a range between −10 and 0 V. The voltage difference may be configured in accordance with real scenarios.

In the embodiment, the voltage value of the common electrode layer 222 is larger than the first driving voltage value of the adjacent first pixel electrode layer 221, and is smaller than the second driving voltage value of the adjacent second pixel electrode layer 223. It can be understood that, in the other embodiment, the voltage value of the common electrode layer 222 is smaller than the first driving voltage value of the adjacent first pixel electrode layer 221, and is greater than the second driving voltage value of the adjacent second pixel electrode layer 223

Preferably, the first voltage difference between the first pixel electrode layer 221 and the common electrode layer 222 is opposite to the second voltage difference between the second pixel electrode layer 223 and the common electrode layer 222. For instance, the first voltage difference between the first pixel electrode layer 221 and the common electrode layer 222 is 5V, and the second voltage difference between the second pixel electrode layer 223 and the common electrode layer 222 is −5V. The voltage difference may be configured in accordance with real scenarios. As the locations of the first pixel electrode layer 221, the common electrode layer 222, and the second pixel electrode layer 223 are different, in order to enhance the transmission rate, the first voltage difference between the first pixel electrode layer 221 and the common electrode layer 222 may be configured to be not opposite to the second voltage difference between the second pixel electrode layer 223 and the common electrode layer 222. For instance, the first voltage difference between the first pixel electrode layer 221 and the common electrode layer 222 is 5V, and the second voltage difference between the second pixel electrode layer 223 and the common electrode layer 222 is −6V. That is, the voltage difference may be configured in accordance with real scenarios.

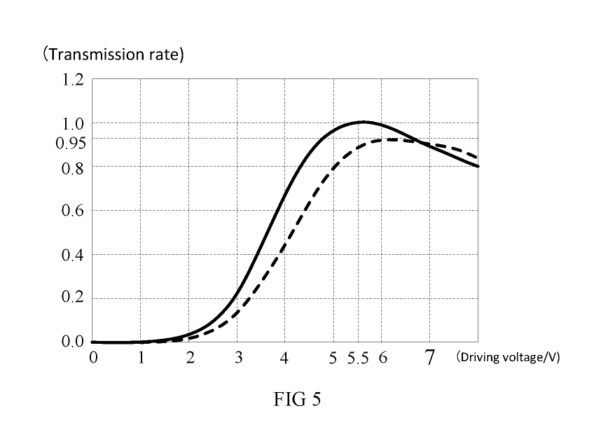

As shown in FIG. 4, the x-axis represents the locations of the pixel electrode layers and the common electrode layers on the second substrate, the left y-axis represents the distance between the first substrate 21 and the second substrate 22, and the right y-axis represents the transmission rate of the display panel. As the first driving voltage value of the first pixel electrode layer 221 is different from the second driving voltage value of the second pixel electrode layer 223, the first voltage difference (V1) between the common electrode layer 222 and the first pixel electrode layer 221 is different from the second voltage difference (V2) between the common electrode layer 222 and the second pixel electrode layer 223. In this way, the horizontal electrical field above the common electrode layer 222 increases and the liquid crystal may be rotated easily, which increases the transmission rate above the common electrode layer 222. Specifically, referring to FIG. 2, the transmission rate above the common electrode layer 122 is 0.5. Referring to FIG. 3, in the embodiment, the transmission rate above the common electrode layer 222 reaches 0.8. that is, the transmission rates of the first pixel electrode layer 221 and the second pixel electrode layer 223 remain the same, and the transmission rate above the common electrode layer 222 increases about 0.5 times. That is, the transmission rate above the common electrode layer 222 increases from the 0.5 toward 0.8. Conventionally, the pixel electrode layer and the common electrode layer are arranged on the TFT array substrate, and the transmission rate of those far away from the TFT array substrate is low. With the increase of the altitude, the transmission rate decreases. On the contrary, the present disclosure may control the driving voltage of the pixel electrode layer such that the transmission rate may not decrease when the altitude increases, which can effectively reduce the cost.

Further, not only the transmission rate may be increased, the power consumption of the display panel may be reduced. As shown in FIG. 5, the x-axis represents the driving voltage, the y-axis represents the transmission rate, solid lines represent the curve of the present disclosure, and the dashed lines represents the curve of the conventional technology. In view of FIG. 5, the driving voltage is about 5.5V when the transmission rate in one embodiment reaches the maximum value, i.e., one. With respect to the conventional technology, the driving voltage is about 6V when the transmission rate reaches the maximum value, i.e., 0.95. It is clear that the driving voltage may be reduced for 0.5 V. In addition, not only the transmission rate is increased, the power consumption of the display panel may be reduced also.

In view of the above, the liquid crystal panel includes the first substrate, the second substrate spaced apart from the first substrate, and the liquid crystal layer between the first substrate and the second substrate. The second substrate includes the ITO layer facing toward the liquid crystal layer. The ITO layer includes the first pixel electrode layer, the common electrode layer, and the second pixel electrode layer spaced apart from each other. The first voltage difference between the common electrode layer and the first pixel electrode layer is different from the second voltage difference between the common electrode layer and the second pixel electrode layer. In view of the above, the intensity of the horizontal electrical field above the common electrode layer may be increased and the transmission rate of the liquid crystal panel may also be enhanced. In addition, the performance of the liquid crystal panel may be enhanced, and the design cost may be reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a first substrate, a second substrate spaced apart from the first substrate, and a liquid crystal layer between the first substrate and the second substrate, the second substrate comprises an ITO layer facing toward the liquid crystal layer, the ITO layer comprises at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer;
wherein the first voltage difference between the first pixel electrode layer and the common electrode layer is opposite to the second voltage difference between the second pixel electrode layer and the common electrode layer;
the common electrode layer is arranged between the first pixel electrode layer and the second pixel electrode layer, and the first pixel electrode layer or the second pixel electrode layer is arranged between two common electrode layers; and
the liquid crystal panel is the liquid crystal panel of IPS mode.

2. The liquid crystal panel as claimed in claim 1, wherein a first driving voltage value of the first pixel electrode layer is different from a second driving voltage value of the second pixel electrode layer.

3. The liquid crystal panel as claimed in claim 2, wherein a voltage value of the common electrode layer is larger than the first driving voltage value of the adjacent first pixel electrode layer, and is smaller than the second driving voltage value of the adjacent second pixel electrode layer.

4. The liquid crystal panel as claimed in claim 1, wherein the first substrate is a color filter array substrate, and the second substrate is a thin film transistor (TFT) array substrate.

5. A liquid crystal panel, comprising:
a first substrate, a second substrate spaced apart from the first substrate, and a liquid crystal layer between the first substrate and the second substrate, the second substrate comprises an ITO layer facing toward the liquid crystal layer, the ITO layer comprises at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer.

6. The liquid crystal panel as claimed in claim 5, wherein the common electrode layer is arranged between the first pixel electrode layer and the second pixel electrode layer, and the first pixel electrode layer or the second pixel electrode layer is arranged between two common electrode layers.

7. The liquid crystal panel as claimed in claim 6, wherein a first driving voltage value of the first pixel electrode layer is different from a second driving voltage value of the second pixel electrode layer.

8. The liquid crystal panel as claimed in claim 7, wherein a voltage value of the common electrode layer is larger than the first driving voltage value of the adjacent first pixel electrode layer, and is smaller than the second driving voltage value of the adjacent second pixel electrode layer.

9. The liquid crystal panel as claimed in claim 5, wherein the first voltage difference is in a range between 0 and 10V and the second voltage difference is in a range between −10 and 0 V.

10. The liquid crystal panel as claimed in claim 5, wherein the second voltage difference is in a range between 0 and 10 V, and the first voltage difference is in a range between −10 and 0 V.

11. The liquid crystal panel as claimed in claim 5, wherein the liquid crystal panel is the liquid crystal panel of IPS mode.

12. The liquid crystal panel as claimed in claim 5, wherein the first substrate is a color filter array substrate, and the second substrate is a TFT array substrate.

13. A display device, comprising:
a liquid crystal panel comprising a first substrate, a second substrate spaced apart from the first substrate, and a liquid crystal layer between the first substrate and the second substrate, the second substrate comprises an ITO layer facing toward the liquid crystal layer, the ITO layer comprises at least one first pixel electrode layer, at least one common electrode layer, and at least one second pixel electrode layer spaced apart from each other, and a first voltage difference between the first pixel electrode layer and the common electrode layer is different from a second voltage difference between the second pixel electrode layer and the common electrode layer.

14. The display device as claimed in claim 13, wherein the common electrode layer is arranged between the first pixel electrode layer and the second pixel electrode layer, and the first pixel electrode layer or the second pixel electrode layer is arranged between two common electrode layers.

15. The display device as claimed in claim 14, wherein a first driving voltage value of the first pixel electrode layer is different from a second driving voltage value of the second pixel electrode layer.

16. The display device as claimed in claim 15, wherein a voltage value of the common electrode layer is larger than the first driving voltage value of the adjacent first pixel electrode layer, and is smaller than the second driving voltage value of the adjacent second pixel electrode layer.

17. The display device as claimed in claim 13, wherein the first voltage difference is in a range between 0 and 10V and the second voltage difference is in a range between −10 and 0 V.

18. The display device as claimed in claim 13, wherein the second voltage difference is in a range between 0 and 10 V, and the first voltage difference is in a range between −10 and 0 V.

19. The display device as claimed in claim 13, wherein the liquid crystal panel is the liquid crystal panel of IPS mode.

20. The display device as claimed in claim 13, wherein the first substrate is a color filter array substrate, and the second substrate is a TFT array substrate.
